(19) United States
(12) Patent Application Publication
(10) Pub. No.: US 2012/0001910 A1
(43) Pub. Date: Jan. 5, 2012

(54) IMAGE DISPLAY APPARATUS, IMAGE DISPLAY METHOD, CURVED LINE SPECIFYING APPARATUS, CURVED LINE SPECIFYING METHOD, AND RECORDING MEDIUM

(75) Inventors: Takashi IJIRI, Wako-shi (JP); Hideo YOKOTA, Wako-shi (JP)

(73) Assignee: RIKEN, Wako-shi (JP)

(21) Appl. No.: 13/018,867

(22) Filed: Feb. 1, 2011

(30) Foreign Application Priority Data
Jun. 30, 2010 (JP) 2010-149497

(51) Int. Cl. G06T 17/00

(52) U.S. Cl. 345/424

(57) ABSTRACT

A curved line specifying apparatus includes a curved surface specifying section for receiving a curved surface specifying operation in which a curved surface S in a virtual three-dimensional space is specified and a cross section image display section for outputting, to a display, the curved surface in which a cross section image of a three-dimensional image is embedded, pixel values of the cross section image being voxel values assigned to voxels on the curved surface S.

This Nonprovisional application claims priority under 35 U.S.C. §119(a) on Patent Application No. 2010-149497 filed in Japan on Jun. 30, 2010, the entire contents of which are hereby incorporated by reference.

### TECHNICAL FIELD

The present invention relates to an image display apparatus and an image display method each of which allows displaying a three-dimensional image, and to a curved line specifying apparatus and a curved line specifying method each of which employs the image display method. The present invention also relates to a computer-readable recording medium in which a program for causing a computer to operate as the image display apparatus or the curved line specifying apparatus is recorded.

### BACKGROUND ART

A three-dimensional image captured by CT (Computed Tomography), MRI (Magnetic Resonance Imaging), a confocal laser microscopy, or the like is extensively used for diagnosis and the like. In order to observe such a three-dimensional image, it is necessary to convert, by some method, information contained in the three-dimensional image to a format which can be outputted to a two-dimensional display.

Such conversion is exemplified by volume rendering, which has been extensively used. Volume rendering is a form of representation of a three-dimensional image in which form voxels of a three-dimensional image are semi-transparent so as to have a transparency in accordance with voxel values, so that these voxels are projected on a screen. Note that a form of representation of a planar cross section image is also effective in which form an x-y plane, a y-z plane, a z-x plane (any other plane that has a normal line), or the like is a cross section.

Patent Literature 1 describes a method in which planar cross section images are sequentially displayed while a cross section is being moved in its normal direction.

### Citation List

Patent Literature 1

Japanese Patent Application Publication, Tokukaihei, No. 6-22966 A (Publication Date: Feb. 1, 1994)

### SUMMARY OF INVENTION

### Technical Problem

However, a conventional display method including the method described in Patent Literature 1 for displaying a planar cross section image of a three-dimensional image is such that a planar cross section image is displayed assuming that a plane is a cross section. This causes a problem that observation of a non-linear or non-planar object requires checking a plurality of planar cross section images. For example, it would be clear that observation of a meandering blood vessel (a non-linear object) or a twisted organ (a non-planar object) requires checking a plurality of planar cross section images. Further, an observer is required to form a three-dimensional image from the plurality of planar cross section images. This is extremely burdensome to a less experienced observer.

The present invention has been made in view of the problems, and an object of the present invention is to provide an image display apparatus and an image display method each of which allows displaying a cross section image by which a non-linear or non-planar object can be observed. Another object of the present invention is to provide, by use of the image display method, a curved line specifying apparatus and a curved line specifying method each of which allows effectively specifying a curved line in a three-dimensional image.

### Solution to Problem

In order to attain the object, an image display apparatus according to the present invention includes: an image obtaining section for obtaining a three-dimensional image which has voxel values assigned to respective voxels of a three-dimensional space; a specifying operation receiving section for receiving a curved surface specifying operation in which a curved surface in the three-dimensional space is specified; and a cross section image display section for outputting, to a display, the curved surface in the three-dimensional space which curved surface has been specified by the curved surface specifying operation and in which curved surface a cross section image of the three-dimensional image is embedded, pixel values of the cross section image being voxel values assigned to voxels on the curved surface.

According to the arrangement, it is possible to display a cross section image such that a curved surface specified by a user by the curved surface specifying operation is assumed to be a cross section. In particular, specification of a curved surface along a non-linear or non-planar object to be observed in a three-dimensional image allows displaying a cross section image by which the object to be observed can be observed. Further, the cross section image is embedded in the curved surface specified by the user, so as to be displayed. Therefore, the user can accurately observe the object to be observed including how it is arranged. Note that the “three-dimensional space”, which is a three-dimensional space of image data, may be herein referred to as a “virtual three-dimensional image”.

In order to attain the object, a curved line specifying apparatus according to the present invention includes: an image obtaining section for obtaining a three-dimensional image which has voxel values assigned to respective voxels of a three-dimensional space; a first specifying operation receiving section for receiving a first curved surface specifying operation in which a first curved surface in the three-dimensional space is specified; a cross section image display section for outputting, to a display, the first curved surface in the three-dimensional space which first curved surface has been specified by the first curved surface specifying operation and in which first curved surface a cross section image of the three-dimensional image is embedded, pixel values of the cross section image being voxel values assigned to voxels on the first curved surface; a second specifying operation receiving section for receiving a second curved surface specifying operation while the cross section image display section is outputting, to the display, the first curved surface in which the cross section image is embedded, the second curved surface specifying operation being an operation in which a second curved surface in the three-dimensional space is specified; and a curved line specifying section for specifying an intersection line of (i) the first curved surface which has been specified by the first curved surface specifying operation and (ii) the second curved surface which has been specified by the second curved surface specifying operation.

According to the arrangement, since the curved line specifying apparatus displays a cross section image as in the case of the image display apparatus, it is possible to display a cross section image by which a non-linear or non-planar object to be observed in a three-dimensional image can be observed. Further, the user can accurately observe the object to be observed including how it is arranged. In addition, while observing the object to be observed of the cross section image, the user can carry out the second curved surface specifying operation in which the second curved surface is specified. Namely, only the curved surface specifying operation carried out two times (the first curved surface specifying operation and the second curved surface specifying operation) allows easy specification of a curved line along a three-dimensional object to be observed in a three-dimensional image.

Note here that the first curved surface can be a curved surface S (γ1) in the three-dimensional space, the curved surface S (γ1) being such that a projection of the curved surface S (γ1) on a screen coincides with a curved line γ1 (drawn by the user) on the screen. Similarly, the second curved surface can be a curved surface S (γ2) in the three-dimensional space, the curved surface S (γ2) being such that a projection of the curved surface S (γ2) on the screen coincides with a curved line γ2 (drawn by the user) on the screen. In this case, it is specified that the intersection line is an intersection line Γ=S (γ1)∩S (γ2) of the two curved surfaces S (γ1) and S (γ2).

In order to attain the object, an image display method according to the present invention includes the steps of: (a) obtaining a three-dimensional image which has voxel values assigned to respective voxels of a three-dimensional space; (b) receiving a curved surface specifying operation in which a curved surface in the three-dimensional space is specified; and (c) outputting, to a display, the curved surface in the three-dimensional space which curved surface has been specified by the curved surface specifying operation and in which curved surface a cross section image of the three-dimensional image is embedded, pixel values of the cross section image being voxel values assigned to voxels on the curved surface.

The arrangement yields an effect similar to that yielded by the image display apparatus.

In order to attain the object, a curved line specifying method according to the present invention includes the steps of: (a) obtaining a three-dimensional image which has voxel values assigned to respective voxels of a three-dimensional space; (b) receiving a first curved surface specifying operation in which a first curved surface in the three-dimensional space is specified; (c) outputting, to a display, the first curved surface in the three-dimensional space which first curved surface has been specified by the first curved surface specifying operation and in which first curved surface a cross section image of the three-dimensional image is embedded, pixel values of the cross section image being voxel values assigned to voxels on the first curved surface; (d) receiving a second curved surface specifying operation while the first curved surface in which the cross section image is embedded is being outputted to the display in the step (c), the second curved surface specifying operation being an operation in which a second curved surface in the three-dimensional space is specified; and (e) specifying an intersection line of (i) the first curved surface which has been specified by the first curved surface specifying operation and (ii) the second curved surface which has been specified by the second curved surface specifying operation.

The arrangement yields an effect similar to that yielded by the curved line specifying apparatus.

### Advantageous Effects of Invention

According to the present invention, it is possible to display a cross section image by which a non-linear or non-planar object to be observed in a three-dimensional image can be observed and also to accurately observe how the object to be observed is arranged.

### BRIEF DESCRIPTION OF DRAWINGS

FIG. 1

FIG. 1, which shows an embodiment of the present invention, is a block diagram of a curved line specifying apparatus.

FIG. 2

FIG. 2, which shows the embodiment of the present invention, is a block diagram of computer which functions as the curved line specifying apparatus illustrated in FIG. 1.

FIG. 3

FIG. 3, which shows the embodiment of the present invention, is a flow chart illustrating operation carried out by the curved line specifying apparatus illustrated in FIG. 1.

FIG. 4(a)

FIG. 4(a), which shows the embodiment of the present invention, illustrates an arrangement of a virtual three-dimensional space in a state in which a first curved surface specifying operation is inputted in which a curved line γ1 is drawn on a screen So.

FIG. 4(b)

FIG. 4(b), which shows the embodiment of the present invention, illustrates an arrangement of the virtual three-dimensional space in a state in which a cross section image I (S1) is embedded in a curved surface S1.

FIG. 4(c)

FIG. 4(c), which shows the embodiment of the present invention, illustrates an arrangement of the virtual three-dimensional space in a state in which a second curved surface specifying operation is inputted in which a curved line γ2 is drawn on a screen So′.

FIG. 4(d)

FIG. 4(d), which shows the embodiment of the present invention, illustrates an arrangement of the virtual three-dimensional space in a state in which an intersection line Γ=S (γ1)∩S (γ2) is specified.

FIG. 5(a)

FIG. 5(a), which shows the embodiment of the present invention, illustrates an example of a picture which is outputted to a display by a cross section image display section of the curved line specifying apparatus illustrated in FIG. 1, especially a picture which is displayed in a case where a viewpoint is set in a three-dimensional image.

FIG. 5(b)

FIG. 5(b), which shows the embodiment of the present invention, illustrates an example of the picture which is outputted to the display by the cross section image display section of the curved line specifying apparatus illustrated in FIG. 1, especially a picture which is displayed in a case where a cross section along a blood vessel is set.

FIG. 6(a)

FIG. 6(a), which shows an example of the present invention, illustrates an example of a picture which is outputted to the display in a state where the curved line γ1 is specified in a volume rendering image of a CT image by the first curved line specifying operation.

FIG. 6(b)

FIG. 6(b), which shows the example of the present invention, illustrates an example of a picture which is outputted to the display in a state where the curved line γ2 is specified in a cross section image of a CT image by the second curved line specifying operation.

FIG. 6(c)

FIG. 6(c), which shows the example of the present invention, illustrates an example of a picture which is outputted to the display in a state where the intersection line which has been specified in the volume rendering image of the CT image.

### DESCRIPTION OF EMBODIMENTS

An embodiment of the present invention is described below with reference to the drawings. Note that an image display apparatus according to the present embodiment is hereinafter referred to as a curved line specifying apparatus since the image display apparatus functions as the curved line specifying apparatus which has a function of specifying a curved line. However, even if the function of specifying a curved line is removed from the curved line specifying apparatus, the curved line specifying apparatus described below is uniquely devised in its image display method, which can be effectively carried out.

[Curved Line Specifying Apparatus]

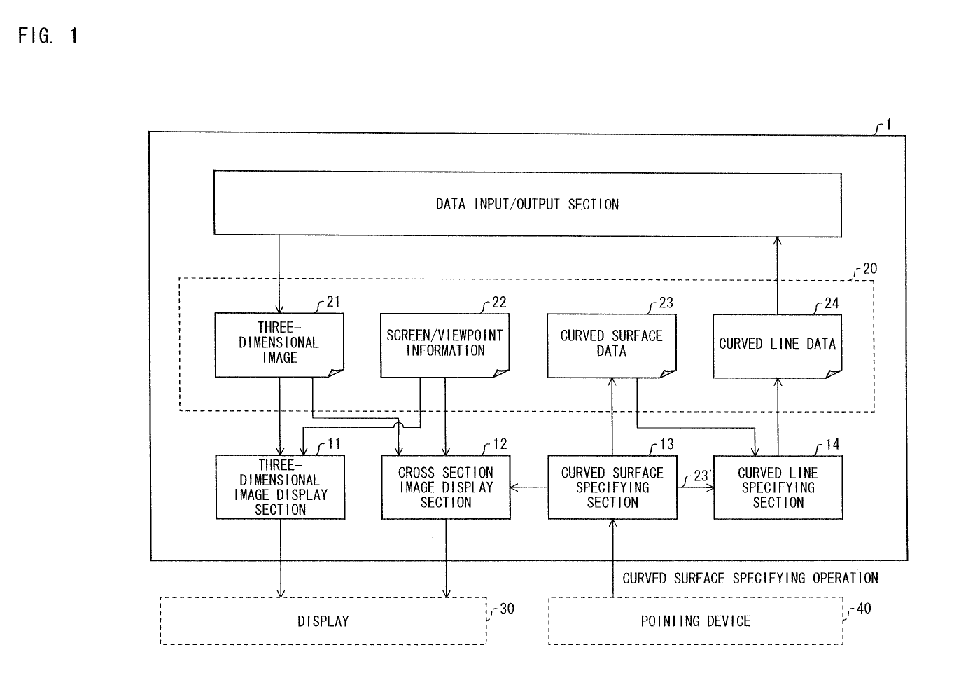

An arrangement of a curved line specifying apparatus 1 according to the present embodiment is described below with reference to FIG. 1.

FIG. 1 is a block diagram illustrating an arrangement of a relevant part of the curved line specifying apparatus 1. The curved line specifying apparatus 1 includes a three-dimensional image display section 11, a cross section image display section 12, a curved surface specifying section 13, a curved line specifying section 14, a data input/output section 15, and a storage section 20 (see FIG. 1).

A three-dimensional image 21, screen/viewpoint information 22, curved surface data 23, and curved line data 24 are stored in the storage section 20. Of these data, the three-dimensional image 21 is input data for the curved line specifying apparatus 1 which input data has been obtained from outside by the data input/output section 15. The curved line specifying apparatus 1 generates the curved line data 24 from the three-dimensional image 21 in response to a curved surface specifying operation inputted by use of a pointing device 40, so as to supply the curved line data 24 thus generated to outside via the data input/output section 15.

The three-dimensional image 21 is a set of voxel values assigned to respective voxels of a virtual three-dimensional space (a three-dimensional space). In a case where the virtual three-dimensional space is constituted by I×J×K voxels, i.e., in a case where the three-dimensional image 21 has a resolution of I×J×K voxels, the three-dimensional image 21 can be represented by the three-dimensional array of {v (i, j, k)|0≦i<I, 0≦j<J, 0≦k<K}. v (i, j, k) is a voxel value assigned to a voxel (i, j, k). The present embodiment assumes that the three-dimensional image 21 is a CT image obtained by capturing an image of a living body.

The screen/viewpoint information 22 is information which the three-dimensional image display section 11 and the cross section image display section 12 refer to so as to three-dimensionally display an object (a region, a curved surface, a curved line etc.) which is provided in the virtual three-dimensional space. Note here that the three-dimensional display of an object indicates that an object is projected on a screen So provided in the virtual three-dimensional space, so that a projected image of the object is outputted to a display 30.

The present embodiment uses perspective projection (central projection) as a projection method. In this case, a point A in an object is projected on an intersection point A′ of (i) a straight line AP defined by the point A and a viewpoint O and (ii) the screen So. The screen/viewpoint information 22 defines how to set the screen So and the viewpoint O. A user can freely set the screen/viewpoint information 22 so as to obtain a desired angle. Note that a usable projection method is not limited to the perspective projection. Namely, parallel projection can also be used instead of the perspective projection.

The curved surface data 23 represents a curved surface S of the virtual three-dimensional space. The curved surface S is specified by the user. The present embodiment assumes that a class of a curved surface which can be specified is a class of a curved surface S=S (γ) which is an inverse projection image of a curved line γ on the screen So, that is, a class of a curved surface S=S (γ) whose projection on the screen So coincides with the curved line γ. In a case where the curved line γ is a curved line such as a spline curve or a Bèzier curve which is represented by a polynomial, the curved surface S (γ) is also represented by a polynomial. In this case, coefficients of the polynomial which represent the curved surface S (γ) can be used as the curved surface data 23. Alternatively, a polygon mesh (e.g., a triangle mesh) which approximates the curved surface S (γ) can be used as the curved surface data 23.

The curved line data 24 represents a curved line Γ of the virtual three-dimensional image. The curved line Γ is specified by the user. The present embodiment assumes that a class of a curved line which can be specified is a class of the curved line Γ=Γ(γ1, γ2) which is given as an intersection line S (γ1)∩S (γ2) of a first curved surface S (γ1) which is an inverse projection image of a first curved line γ1 and a second curved surface S (γ2) which is an inverse projection image of a second curved line γ2. Note that (i) the screen So and the viewpoint O which are used to project the first curved surface S (γ1) on the first curved line γ1 and (ii) a screen So′ and a viewpoint O′ which are used to project the second curved surface S (γ2) on the second curved line γ2 can be identical (So=So′ and O=O′) or different (So≠So′ or O≠O′).

Note that, in a case where the first curved surface S (γ1) and the second curved surface S (γ2) are represented by respective polynomials, the curved line Γ=Γ(γ1, γ2) is also represented by a polynomial. In this case, coefficients of the polynomial which represent the curved line F (γ1, γ2) can be used as the curved line data 24. Note that, in a case where the first curved surface S (γ1) and the second curved surface S (γ2) are represented by a polygon mesh M1 and a polygon mesh M2, respectively, a polyline whose edge is an intersection line of a face of the polygon mesh M1 and a face of the polygon mesh M2 can be used as the curved line data 24.

The three-dimensional image display section 11 serves as means for three-dimensionally displaying the three-dimensional image 21. The three-dimensional display of the three-dimensional image 21 is realized by carrying out volume rendering with respect to the three-dimensional image 21. Volume rendering is carried out by causing the voxels of the three-dimensional image to be semi-transparent so that the voxels have a transparency in accordance with voxel values, so as to project these voxels on the screen So. In this case, the three-dimensional image display section 11 determines an angle (how to set the visual pint O and the screen So) with reference to the screen/viewpoint information 22 stored in the storage section 20. The three-dimensional image 21 which has been subjected to volume rendering serves as a guide for the user to specify where the first curved surface is set.

Note that, in a case where region extraction is separately carried out with respect to the three-dimensional image 21, the arrangement such that the three-dimensional image 21 is subjected to volume rendering can be replaced with an arrangement such that the three-dimensional image display section 11 causes voxels which belong to an extracted region to be opaque, so as to project these voxels on the screen So.

The curved surface specifying section 13 serves as means for receiving the input of the curved surface specifying operation in which the curved surface S is specified. According to the present embodiment, the curved surface specifying section 13 further generates the curved surface data 23 which represents the curved surface S which has been specified by the curved surface specifying operation.

According to the present embodiment, the curved surface specifying operation received by the curved surface specifying section 13 refers to a line drawing operation (a stroke operation) in which the curved line γ is drawn on the screen So by use of the pointing device 40 such as a mouse or a trackpad. In response to an input of the line drawing operation in which the curved line γ is drawn on the screen So, the curved surface specifying section 13 refers to the screen/viewpoint information 22 stored in the storage section 20, so as to derive, based on curved line data which represents the curved line γ (e.g., coefficients of a polynomial which represent the curved line γ), the curved surface data 23 which represents the curved surface S (γ) such that a projection on the screen So coincides with the curved line γ (e.g., coefficients of the polynomial which represent the curved surface S (γ)). Note that, in a case where γ is a straight line, S (γ) is a plane.

The curved surface specifying section 13 receives, as a first curved surface specifying operation to specify the first curved surface S1=S(γ1), the curved surface specifying operation which has been carried out while the three-dimensional image display section 11 (described earlier) is displaying the three-dimensional image 21, so as to supply, to the cross section image display section 12, the curved surface data 23 which represents the first curved surface S1 and to store the curved surface data 23 in the storage section 20. The curved surface specifying section 13 receives, as a second curved surface specifying operation to specify the second curved surface S2=S (γ2), the curved surface specifying operation which has been carried out while the cross section image display section 12 (described later) is displaying a cross section image I (S1), so as to supply, to the curved line specifying section 14, curved surface data 23′ which represents the second curved surface S2 and to store the curved surface data 23′ in the storage section 20.

The cross section image display section 12 serves as means for generating the cross section image I (S1) of the three-dimensional image 21 whose cross section is the first curved surface S1 which has been specified by the first curved surface specifying operation and for three-dimensionally displaying, on the display 30, the first curved surface S1 in which the cross section image I (S1) is embedded (placed). The cross section image display section 12 can also be referred to as means for three-dimensionally displaying, on the display 30, the first curved surface S1 whose texture is the cross section image I (S1). The cross section image I (S1) can be generated by specifying voxels which intersect the first curved surface S1 in the virtual three-dimensional space, so as to sample (extract) a voxel value assigned to the specified voxels. Note that a voxel which intersects the first curved surface S1 can be easily found based on the curved surface data 23 supplied from the curved surface specifying section 13.

The cross section image display section 12 determines an angle (how to set the visual pint O and the screen So) with reference to the screen/viewpoint information 22 stored in the storage section 20, so as to display the cross section image I (S1). The cross section image display section 12 updates the angle immediately in response to update of the screen/viewpoint information 22 by the user. This allows the user to observe the cross section image I (S1) from a desired angle. For example, also in a case where an object to be observed is complicatedly meandering in the virtual three-dimensional space as in the case of a vascular region of a CT image, the whole object to be observed can be viewed by a single cross section image (S1), provided that the first curved surface S1 is set so as to be along the object to be observed.

The curved line specifying section 14 generates, from the curved surface data 23 read out from the storage section 20 (representing the first curved surface S1) and the curved surface data 23′ obtained from the curved surface specifying section 13 (representing the second curved surface S2), the curved line data 24 which represents the intersection line Γ=S1 (γ1)∩S2 (γ2) of the first curved surface S1 which has been specified by the first curved surface specifying operation and the second curved surface S2 which has been specified by the second curved surface specifying operation. In a case where the first curved surface S1 and the second curved surface S2 are represented by respective polynomials, coefficients of a polynomial which represent the curved line Γ can be found by algebra calculation based on coefficients of the polynomial which represent the first curved surface S1 and coefficients of the polynomial which represent the second curved surface S2.

In the case where the first curved surface S1 and the second curved surface S2 are represented by the polygon mesh M1 and the polygon mesh M2, respectively, edges of the polyline which represents the curved line Γ can be found by calculating the intersection line of the face of the polygon mesh M1 and the face of the polygon mesh M2.

Note that the intersection line Γ can be specified by a set of voxels which intersect the intersection line Γ instead of coefficients of a polynomial which represent the intersection line Γ or edges of a polyline which represents the intersection line Γ. In this case, it is possible to generate a first binary image in which only a voxel which intersects the first curved surface S1 has a value of 1 (other voxels which do not intersect the first curved surface S1 have a value of 0 (zero)) and a second binary image in which only a voxel which intersects the second curved surface S2 has a value of 1 (other voxels which do not intersect the second curved surface S2 have a value of 0 (zero)), so as to carry out AND operation with respect to the two binary images thus generated and to use these binary images as the curved line data 24.

The curved line specifying section 14 can have a region extraction (Volume Segmentation) function of extracting a cylindrical (string-like) region whose central axis is the curved line Γ. The curved line specifying section 14 can be provided with the region extraction function such that (i) a cylinder whose central axis is the curved line Γ and which has a given radius is extracted or (ii) Region Growing is carried out centering about the curved line Γ. In the case (i), it is desirable to allow the user to freely set the given radius. Such a region extraction function can be suitably used for, for example, extraction of a blood vessel in a CT image.

[Example of Arrangement of the Curved Line Specifying Apparatus]

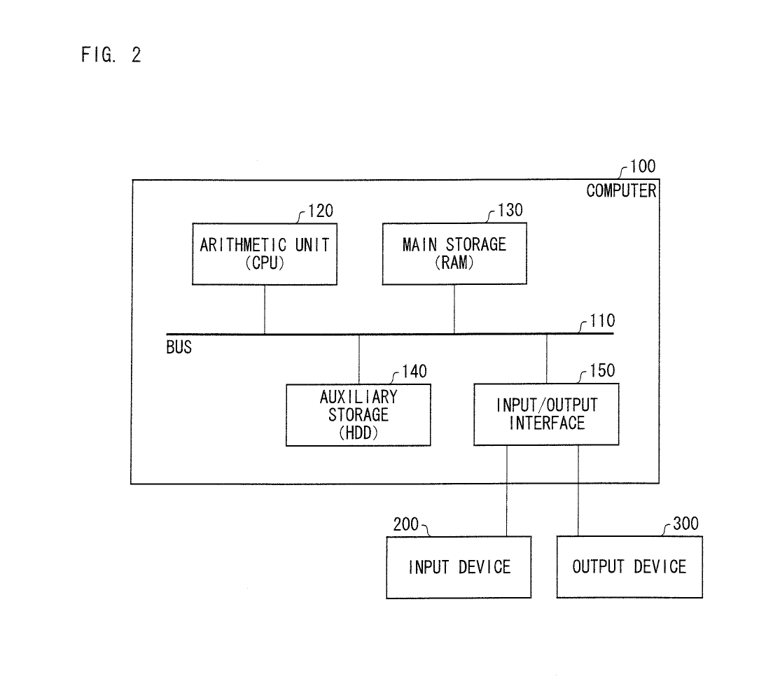

The curved line specifying apparatus 1 can be realized by use of a computer (an electronic computer). FIG. 2 is a block diagram illustrating an arrangement of a computer 100 which is usable as the curved line specifying apparatus 1.

The computer 100 includes an arithmetic unit 120, a main storage 130, an auxiliary storage 140, and an input/output interface 150 which are connected to each other via a bus 110 (see FIG. 2). A device which is usable as the arithmetic unit 120 is exemplified by a CPU (Central Processing Unit). A device which is usable as the main storage 130 is exemplified by a semiconductor RAM (random access memory). A device which is usable as the auxiliary storage 140 is exemplified by a hard disk drive.

Each of an input device 200 and an output device 300 is connected to the input/output interface 150 (see FIG. 2). The input device 200 which is connected to the input/output interface 150 is exemplified by the pointing device 40 (see FIG. 1) by which the curved surface specifying operation (specifically the line drawing operation) is carried out. The output device 300 which is connected to the input/output interface 150 is exemplified by the display 30 (see FIG. 1) on which the volume rendering image or the cross section image is displayed.

Various programs for causing the computer 100 to operate as the curved line specifying apparatus 1 are stored in the auxiliary storage 140. Specifically, a three-dimensional image display program, a cross section image display program, a curved surface specifying program, a curved line specifying program, and a data input/output program are stored in the auxiliary storage 140.

The arithmetic unit 120 expands, into the main storage 130, the various programs stored in the auxiliary storage 140 and carries out commands included in the respective various programs which have been expanded into the main storage 130, so as to cause the computer 100 to operate as each of the three-dimensional image display section 11, the cross section image display section 12, the curved surface specifying section 13, the curved line specifying section 14, and the data input/output section 15.

The main storage 130 functions as the storage section 20 (see FIG. 1) in which the three-dimensional image 21, the screen/viewpoint information 22 22, the curved surface data 23, and the curved line data 24 to each of which the arithmetic unit 120 refers are stored. The three-dimensional image 21 which has been obtained from outside by the data input/output section 15 is stored in the main storage 130 for use.

Note that the arrangement is described here such that the computer 100 functions as the curved line specifying apparatus 1 by use of the various programs recorded in the auxiliary storage 140 which is an internal recording medium. However, the present invention is not limited to this. Namely, an arrangement can be employed such that the computer 100 functions as the curved line specifying apparatus 1 by use of a program recorded in an external recording medium. Any computer-readable recording medium is usable as the external recording medium. The external recording medium can be realized by: (i) tapes such as a magnetic tape and a cassette tape, (ii) disks including magnetic disks such as a floppy (registered trademark) and a hard disk and optical disks such as a CD-ROM, an MO, an MD, a DVD, and a CD-R, (iii) cards such as an IC card (including a memory card) and an optical card, (iv) semiconductor memories such as a mask ROM, EPROM, EEPROM, a flash ROM, and (v) the like.

Note that the computer 100 can be arranged to be connectable to a communication network so that each of program codes mentioned above is supplied to the computer 100 via the communication network. The communication network is not particularly limited and is exemplified by the Internet, intranet, extranet, LAN, ISDN, VAN, a CATV communication network, a virtual private network, a telephone circuit network, a mobile communication network, a satellite communication network. A transmission medium which constitutes the communication network is not particularly limited and is exemplified by wired transmission media such as IEEE1394, USB, a power-line carrier, a cable TV circuit, a telephone line, and ADSL and wireless transmission media such as infrared systems including IrDA and a remote controller, Bluetooth (registered trademark), 802.11 wireless network, HDR, a mobile phone network, a satellite circuit, and a terrestrial digital network.

Note that instead of the arrangement such that each of the display 30 and the pointing device 40 is connected to the computer 100 via the input/output interface 150, it is possible to employ (1) an arrangement (used for a laptop PC etc.) such that the display 30 and the pointing device 40 are provided in the computer 100 or (2) an arrangement (used for a tablet PC etc.) such that a touch panel display which functions as both the display 30 and the pointing device 40 is provided in the computer 100.

[Curved Line Specifying Method]

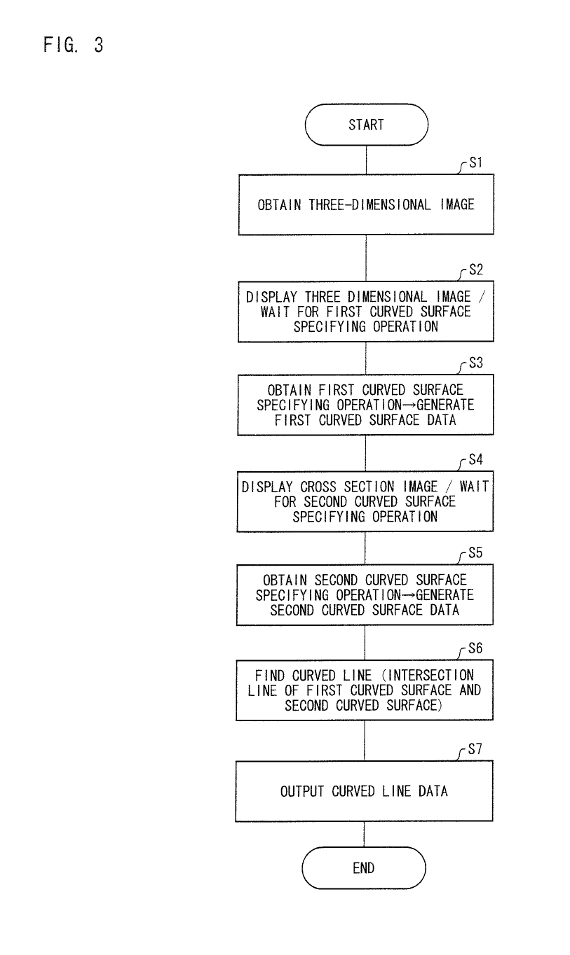

A flow of a curved line specifying process carried out by the curved line specifying apparatus 1 is described below with reference to FIG. 3. FIG. 3 is a flow chart illustrating a flow of the curved line specifying process carried out by the curved line specifying apparatus 1. The following description discusses, in order, steps in the curved line specifying process carried out by the curved line specifying apparatus 1.

Step S1: The data input/output section 15 obtains the three-dimensional image 21 from outside, so as to store the three-dimensional image 21 thus obtained in the storage section 20.

Step S2: The three-dimensional image display section 11 displays, on the display 30, a volume rendering image of the three-dimensional image 21 stored in the storage section 20, and the curved surface specifying section 13 waits for an input of the first curved surface specifying operation in which the first curved surface S1 is specified. The volume rendering image of the three-dimensional image 21, which volume rendering image is outputted to the display 30, allows the user to carry out the first curved surface specifying operation while visually inspecting a surface of an object.

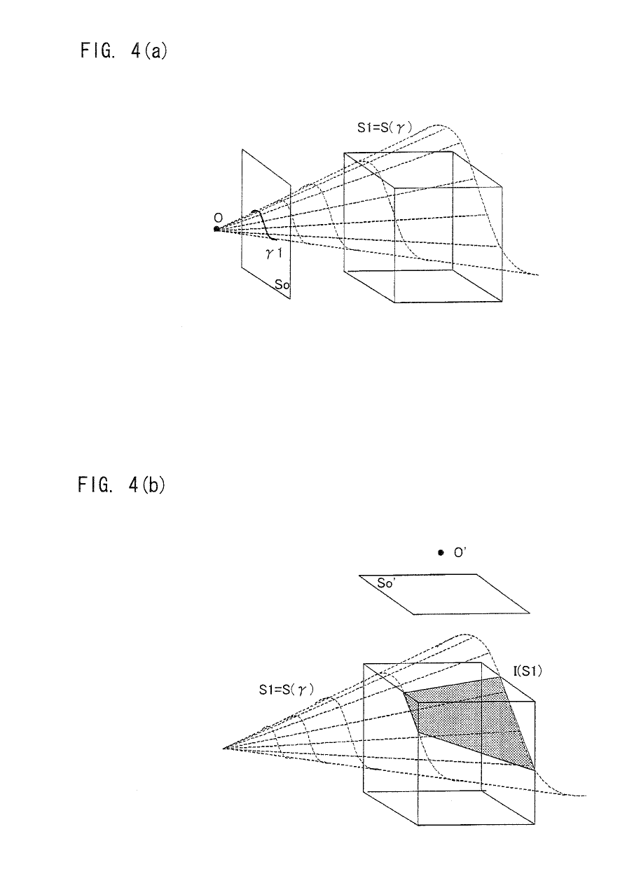

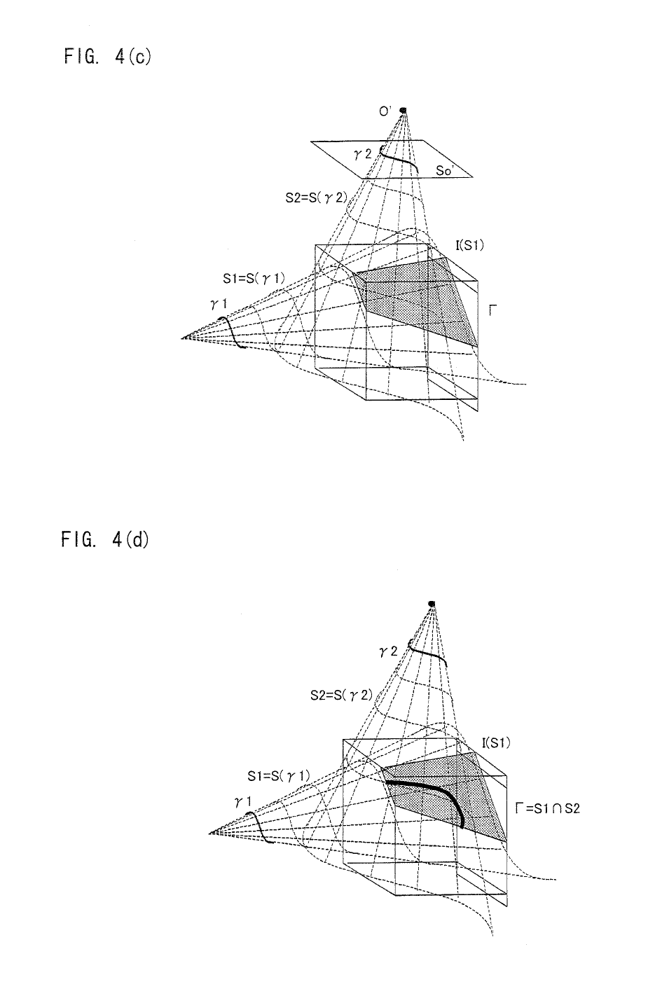

Step S3: In response to the input, as the first curved surface specifying operation, of the first curved surface specifying operation in which the first curved line γ1 is drawn on the screen So, the curved surface specifying section 13 generates the curved surface data 23 which represents the first curved surface S1=S (γ1), so as to store the curved surface data 23 thus generated in the storage section 20. FIG. 4(a) illustrates an arrangement of the virtual three-dimensional space in a state in which the first curved surface specifying operation is inputted in which the first curved line γ1 is drawn on the screen So.

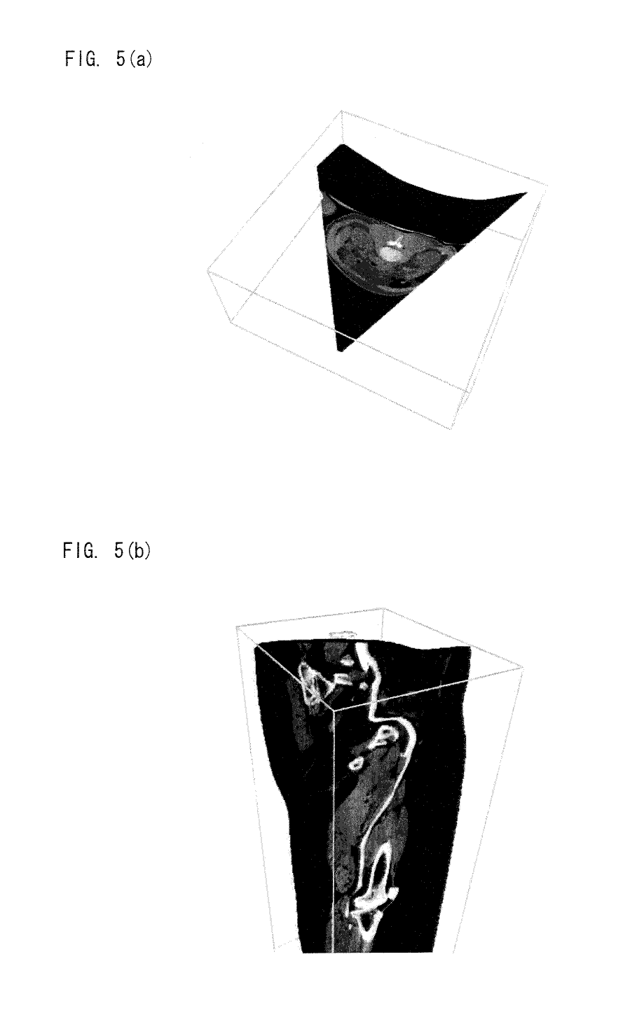

Step S4: The cross section image display section 12 displays, on the display 30, the first curved surface S1 in which the cross section image I (S1) is embedded, and the curved surface specifying section 13 waits for an input of the second curved surface specifying operation in which the second curved surface S2 is specified. The cross section image I (S1), which is embedded in the first curved surface S1, allows the user to carry out the second curved surface specifying operation while visually inspecting a cross section (a S1 cross section) of an object. FIG. 4(b) illustrates an arrangement of the virtual three-dimensional space in the state in which the cross section image I (S1) is embedded in the curved surface S1. FIGS. 5(a) and 5(b) illustrate examples of pictures each illustrating the state in which the cross section image I (S1) is embedded in the first curved surface S1. FIG. 5(a) is a picture which is displayed in a case where a viewpoint is set in the virtual three-dimensional image (a volume box), and FIG. 5(b) is a picture which is displayed in a case where the first curved surface S1 along a meandering blood vessel is set.

Step S5: In response to the input, as the second curved surface specifying operation, of the second curved surface specifying operation in which the second curved line γ2 is drawn on the screen So′, the curved surface specifying section 13 generates the curved surface data 23′ which represents the second curved surface S2=S (γ2), so as to supply the curved surface data 23′ thus generated to the curved line specifying section 14. FIG. 4(c) illustrates an arrangement of the virtual three-dimensional space in a state in which the second curved surface specifying operation in which the second curved line γ2 is drawn on the screen So′.

Step S6: The curved line specifying section 14 generates, from the curved surface data 23 read out from the storage section 20 (curved surface data which has been generated in Step S3 and represents the first curved surface S1) and the curved surface data 23′ obtained from the curved surface specifying section 13 (curved surface data which has been generated in Step S5 and represents the second curved surface S2), the curved line data 24 which represents the intersection line Γ=S (γ1)∩S (γ2) of the first curved surface S1 which has been specified by the first curved surface specifying operation and the second curved surface S2 which has been specified by the second curved surface specifying operation. The curved line data 24 generated by the curved line specifying section 14 is stored in the storage section 20 and supplied to the data input/output section 15. FIG. 4(d) illustrates an arrangement of the virtual three-dimensional space in a state in which the intersection line Γ=S (γ1)∩S (γ2) is specified.

Step S7: The data input/output section 15 supplies, to outside, the curved line data 24 which has been generated in Step S6.

### Specific Example

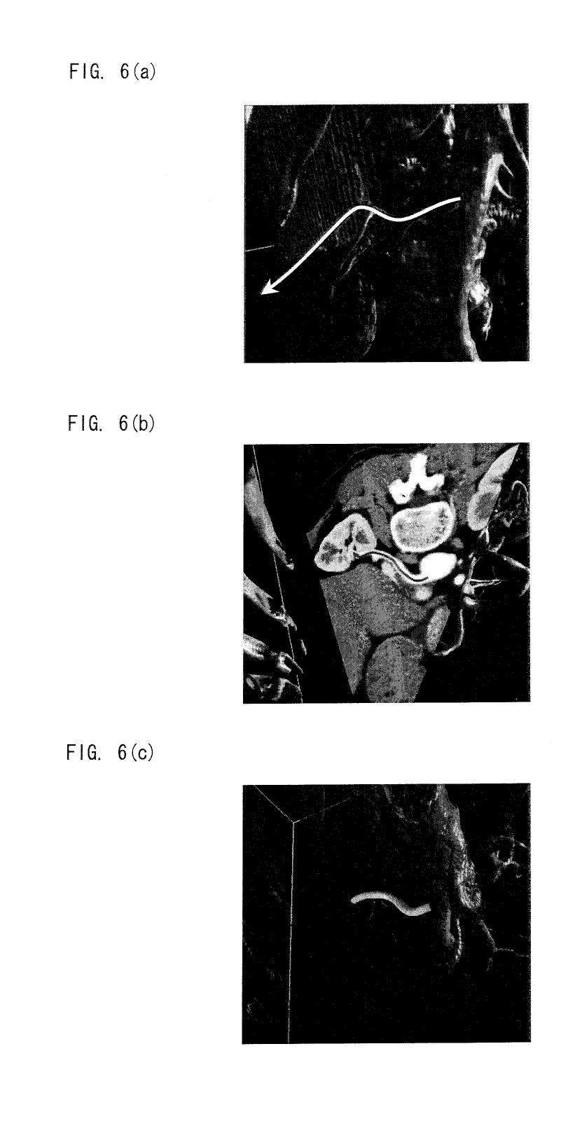

Finally, a specific example of the curve specification carried out by use of the curved line specifying apparatus 1 is described below with reference to FIG. 6. FIG. 6 illustrates a process in which a region which corresponds to a blood vessel is extracted from a CT image by use of the curved line specifying apparatus 1.

FIG. 6(a) is a picture illustrating a volume rendering image displayed in STEP 2 of the flow chart of FIG. 3. This volume rendering image shows a plurality of meandering blood vessels. A whitened arrow of FIG. 6(a) is the first curved line γ1 which the user has drawn along one of the plurality of meandering blood vessels. FIG. 6(b) is a picture illustrating the cross section image I (S1) of the first curved surface S1=S (γ1) which corresponds to the first curved line γ1. The cross section image I (S1) is displayed in a fan-shaped area at the center of FIG. 6(b). Note that, though a blood vessel which is shown in white at the center of FIG. 6(a) is three-dimensionally meandering, the whole blood vessel is shown in a single cross section image I (S1) in FIG. 6(b). A black curve drawn on the blood vessel which is shown in white at the center of FIG. 6(b) is the second curved line γ2 drawn by the user. FIG. 6(c) illustrates the curved line Γ found by the first and second curved lines γ1 and γ2. As described earlier, use of the curved line specifying apparatus 1 allows even a meandering blood vessel to be spatially accurately traced by use of a single cross section image.

### SUMMARY

As described earlier, an image display apparatus according to the present embodiment in which image display apparatus a three-dimensional image which has voxel values assigned to respective voxels of a three-dimensional space is displayed, the image display apparatus includes: a curved surface specifying section for receiving a curved surface specifying operation in which a curved surface in the three-dimensional space is specified; and a cross section image display section for outputting, to a display, the curved surface in the three-dimensional space which curved surface has been specified by the curved surface specifying operation and in which curved surface a cross section image of the three-dimensional image is embedded, pixel values of the cross section image being voxel values assigned to voxels on the curved surface.

According to the arrangement, it is possible to display a cross section image in which a curved surface specified by a user by the curved surface specifying operation is a cross section. In particular, specification of a curved surface along a non-linear or non-planar object to be observed in a three-dimensional image allows displaying a cross section image by which the object to be observed can be observed. Further, the cross section image is embedded in the curved surface specified by the user, so as to be displayed. Therefore, the user can accurately observe the object to be observed including how it is arranged. Note that the “three-dimensional space”, which is a three-dimensional space of image data, may be herein referred to as a “virtual three-dimensional image”.

The image display apparatus according to the present embodiment is desirably arranged such that: the curved surface which can be specified by the curved surface specifying operation is a curved surface whose projection on a screen which is provided in the three-dimensional space is a curved line; and the curved surface specifying operation is an operation in which the projection on the screen of the curved surface which should be specified is specified by a user.

According to the arrangement, the user carries out a two-dimensional operation in which a curved line is specified on a screen, so as to easily specify a three-dimensional object, i.e., a curved surface in a three-dimensional space. Namely, the curved surface is a curved surface S (γ) of the three-dimensional space, the curved surface S (γ) being such that a projection on the screen coincides with a curved line γ (drawn by the user) on the screen.

The image display apparatus according to the present embodiment is preferably arranged to further include: a three-dimensional image display section for displaying the three-dimensional image by volume rendering while the curved surface specifying section is receiving the curved surface specifying operation.

According to the arrangement, while observing the object to be observed of the three-dimensional image, the user can carry out the curved surface specifying operation in which the curved surface is specified.

The image display apparatus according to the present embodiment is preferably arranged such that: the three-dimensional image is obtained by capturing an image of a living body; and the curved surface which is displayed by the cross section image display section has a region which corresponds to a string-like tissue in the three-dimensional image.

According to the arrangement, it is possible to accurately observe a string-like tissue such as a meandering blood vessel.

A curved line specifying apparatus according to the present embodiment in which curved line specifying apparatus a curved line of a three-dimensional space is specified in accordance with a three-dimensional image which has voxel values assigned to respective voxels of the three-dimensional space, the curved line specifying apparatus includes: a first curved surface specifying section for receiving a first curved surface specifying operation in which a first curved surface in the three-dimensional space is specified; a cross section image display section for outputting, to a display, the first curved surface in the three-dimensional space which first curved surface has been specified by the first curved surface specifying operation and in which first curved surface a cross section image of the three-dimensional image is embedded, pixel values of the cross section image being voxel values assigned to voxels on the first curved surface; a second curved surface specifying section for receiving a second curved surface specifying operation while the cross section image display section is outputting, to the display, the first curved surface in which the cross section image is embedded, the second curved surface specifying operation being an operation in which a second curved surface in the three-dimensional space is specified; and a curved line specifying section for specifying an intersection line of (i) the first curved surface which has been specified by the first curved surface specifying operation and (ii) the second curved surface which has been specified by the second curved surface specifying operation.

According to the arrangement, since the curved line specifying apparatus displays a cross section image as in the case of the image display apparatus, the user can accurately observe the object to be observed including how it is arranged. In addition, while observing the object to be observed in the cross section image, the user can carry out the second curved surface specifying operation in which the second curved surface is specified. Namely, only a two-dimensional operation of curved line drawing allows easy specification of a curved line along a three-dimensional object to be observed in a three-dimensional image.

Note here that the first curved surface can be a curved surface S (γ1) of the three-dimensional space, the curved surface S (γ1) being such that a projection on a screen coincides with a curved line γ1 (drawn by the user) on the screen. Similarly, the second curved surface can be a curved surface S (γ2) of the three-dimensional space, the curved surface S (γ2) being such that a projection on the screen coincides with a curved line γ2 (drawn by the user) on the screen. In this case, it is specified that the intersection line is an intersection line Γ=S (γ1)∩S (γ2) of the two curved surfaces S (γ1) and S (γ2).

The curved line specifying apparatus according to the present embodiment is preferably arranged such that the cross section image display section updates an angle according to operation carried out by a user, so as to output, to the display, the first curved surface in which the cross section image is embedded.

According to the arrangement, it is easily specify a curved line along a three-dimensionally curved object to be observed which extends in any direction.

The curved line specifying apparatus according to the present embodiment is preferably arranged such that: the three-dimensional image is obtained by capturing an image of a living body; and the curved line specifying apparatus specifies the curved line which corresponds to a string-like tissue in the three-dimensional image.

According to the arrangement, it is possible to accurately observe a string-like tissue such as a meandering blood vessel.

An image display method according to the present embodiment in which image display method a three-dimensional image which has voxel values assigned to respective voxels of a three-dimensional space is displayed, the image display method includes the steps of: (a) receiving a curved surface specifying operation in which a curved surface in the three-dimensional space is specified; and (b) outputting, to a display, the curved surface in the three-dimensional space which curved surface has been specified by the curved surface specifying operation and in which curved surface a cross section image of the three-dimensional image is embedded, pixel values of the cross section image being voxel values assigned to voxels on the curved surface.

The arrangement yields an effect similar to that yielded by the image display apparatus.

A curved line specifying method according to the present embodiment in which curved line specifying method a curved line of a three-dimensional space is specified in accordance with a three-dimensional image which has voxel values assigned to respective voxels of the three-dimensional space, the curved line specifying method includes the steps of: (a) receiving a first curved surface specifying operation in which a first curved surface in the three-dimensional space is specified; (b) outputting, to a display, the first curved surface in the three-dimensional space which first curved surface has been specified by the first curved surface specifying operation and in which first curved surface a cross section image of the three-dimensional image is embedded, pixel values of the cross section image being voxel values assigned to voxels on the first curved surface; (c) receiving a second curved surface specifying operation while the first curved surface in which the cross section image is embedded is being outputted to the display in the step (b), the second curved surface specifying operation being an operation in which a second curved surface in the three-dimensional space is specified; and (d) specifying an intersection line of (i) the first curved surface which has been specified by the first curved surface specifying operation and (ii) the second curved surface which has been specified by the second curved surface specifying operation.

The arrangement yields an effect similar to that yielded by the curved line specifying apparatus.

A program for causing a computer to function as the region display apparatus or the curved line specifying apparatus and a computer-readable recording medium in which the program is recorded are both encompassed in the scope of the present embodiment.

[Additional Description]

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is suitably usable for observation of a three-dimensional image, especially observation of a medial image such as a CT (Computed Tomography) image. The present invention is usable for a region specification (a region extraction) in a three-dimensional image, especially a region specification in a medical image such as a CT (Computed Tomography) image.

### Reference Signs List

1 Curved line specifying apparatus (Image display apparatus)
11 Three-dimensional image display section
12 Cross section image display section
13 Curved surface specifying section (Specifying operation receiving section, First specifying operation receiving section, Second specifying operation receiving section)
14 Curved line specifying section
15 Data input/output section (Image obtaining section)
20 Storage section
21 Three-dimensional image
22 Screen/Viewpoint information
23 Curved surface data
23′ Curved surface data
24 Curved surface data
30 Display
40 Pointing device

1. An image display apparatus comprising:
an image obtaining section for obtaining a three-dimensional image which has voxel values assigned to respective voxels of a three-dimensional space;
a specifying operation receiving section for receiving a curved surface specifying operation in which a curved surface in the three-dimensional space is specified; and
a cross section image display section for outputting, to a display, the curved surface in the three-dimensional space which curved surface has been specified by the curved surface specifying operation and in which curved surface a cross section image of the three-dimensional image is embedded, pixel values of the cross section image being voxel values assigned to voxels on the curved surface.

2. The image display apparatus as set forth in claim 1, wherein:
the curved surface specifying operation is a line drawing operation in which a curved line is drawn on a screen provided in the three-dimensional space; and
the curved surface specified by the curved surface specifying operation is a curved surface whose projection on the screen coincides with the curved line drawn by the line drawing operation.

3. The image display apparatus as set forth in claim 1, further comprising:
a three-dimensional image display section for displaying the three-dimensional image by volume rendering while the specifying operation receiving section is receiving the curved surface specifying operation.

4. The image display apparatus as set forth in claim 1, wherein:
the three-dimensional image is obtained by capturing an image of a living body; and
the curved surface which is displayed by the cross section image display section and in which the cross section image is embedded has a curved line which corresponds to a string-like tissue in the three-dimensional image.

5. A curved line specifying apparatus comprising:
an image obtaining section for obtaining a three-dimensional image which has voxel values assigned to respective voxels of a three-dimensional space;
a first specifying operation receiving section for receiving a first curved surface specifying operation in which a first curved surface in the three-dimensional space is specified;
a cross section image display section for outputting, to a display, the first curved surface in the three-dimensional space which first curved surface has been specified by the first curved surface specifying operation and in which first curved surface a cross section image of the three-dimensional image is embedded, pixel values of the cross section image being voxel values assigned to voxels on the first curved surface;
a second specifying operation receiving section for receiving a second curved surface specifying operation while the cross section image display section is outputting, to the display, the first curved surface in which the cross section image is embedded, the second curved surface specifying operation being an operation in which a second curved surface in the three-dimensional space is specified; and
a curved line specifying section for specifying an intersection line of (i) the first curved surface which has been specified by the first curved surface specifying operation and (ii) the second curved surface which has been specified by the second curved surface specifying operation.

6. The curved line specifying apparatus as set forth in claim 5, wherein the cross section image display section updates an angle according to operation carried out by a user, so as to output, to the display, the first curved surface in which the cross section image is embedded.

7. The curved line specifying apparatus as set forth in claim 5, wherein:
the three-dimensional image is obtained by capturing an image of a living body; and
the curved line which is specified by the curved line specifying section corresponds to a string-like tissue in the three-dimensional image.

8. An image display method comprising the steps of:
(a) obtaining a three-dimensional image which has voxel values assigned to respective voxels of a three-dimensional space;
(b) receiving a curved surface specifying operation in which a curved surface in the three-dimensional space is specified; and
(c) outputting, to a display, the curved surface in the three-dimensional space which curved surface has been specified by the curved surface specifying operation and in which curved surface a cross section image of the three-dimensional image is embedded, pixel values of the cross section image being voxel values assigned to voxels on the curved surface.

9. A curved line specifying method comprising the steps of:
(a) obtaining a three-dimensional image which has voxel values assigned to respective voxels of a three-dimensional space;
(b) receiving a first curved surface specifying operation in which a first curved surface in the three-dimensional space is specified;
(c) outputting, to a display, the first curved surface in the three-dimensional space which first curved surface has been specified by the first curved surface specifying operation and in which first curved surface a cross section image of the three-dimensional image is embedded, pixel values of the cross section image being voxel values assigned to voxels on the first curved surface;
(d) receiving a second curved surface specifying operation while the first curved surface in which the cross section image is embedded is being outputted to the display in the step (c), the second curved surface specifying operation being an operation in which a second curved surface in the three-dimensional space is specified; and
(e) specifying an intersection line of (i) the first curved surface which has been specified by the first curved surface specifying operation and (ii) the second curved surface which has been specified by the second curved surface specifying operation.

10. A computer-readable recording medium in which a program is recorded for causing a computer to operate as an image display apparatus recited in claim 1, the program causing the computer to function as each section of the image display apparatus.

11. A computer-readable recording medium in which a program is recorded for causing a computer to operate as a curved line specifying apparatus recited in claim 5, the program causing the computer to function as each section of the curved line specifying apparatus.
